(19) United States
(12) Patent Application Publication
(10) Pub. No.: US 2009/0089342 A1
(43) Pub. Date: Apr. 2, 2009

(54) ELECTRONIC DEVICE AND METHOD FOR MANAGING STORAGE OF DATA

(75) Inventors: Christopher James RUNSTEDLER, Cambridge (CA); Brian Roy GROUX, Waterloo (CA); Rohit Rocky JAIN, Waterloo (CA)

Correspondence Address: BORDEN LADNER GERVAIS LLP, 1200 WATERFRONT CENTRE, 200 BURRARD ST., P.O. BOX 48600, VANCOUVER, BC, V7X 1T2, CA

(73) Assignee: RESEARCH IN MOTION LIMITED, Waterloo (CA)

(21) Appl. No.: 12/055,883

(22) Filed: Mar. 26, 2008

Related U.S. Application Data
(60) Provisional application No. 60/976,328, filed on Sep. 28, 2007.

(51) Int. Cl. G06F 17/00

(52) U.S. Cl. 707/204; 707/E17.007

(57) ABSTRACT

A method of managing storage of data at an electronic device includes maintaining databases associated with respective PIM service accounts including at least a first database associated with a first PIM service account and a second database associated with a second PIM service account, receiving a selection of an option to save a data record stored in the first database to the second database, and storing the record in the second database.

### CROSS-REFERENCE TO RELATED APPLICATIONS

This application claims the benefit of U.S. Provisional Application No. 60/976,328, filed Sep. 28, 2007.

### TECHNICAL FIELD

The present application relates to electronic devices with PIM applications for storage and display of PIM application data records such as calendar event records and address book records.

### BACKGROUND DISCUSSION

Many electronic devices such as desktop computers or mobile stations including simple cellular telephones, smart telephones, wireless personal digital assistants (PDAs), and laptop computers with wireless 802.11 or Bluetooth capabilities, include PIM applications for storing PIM records such as calendar or date-book applications for scheduling and reviewing time-dependent events such as appointment and meeting records in a graphical user interface and address book applications for storing and viewing contact data records in a graphical user interface. The information relating to time-dependent events such as time, place and duration is saved as a time-dependent event and is viewable in the graphical user interface in various layouts such as a day view, a week view or a month view. Such applications are useful for maintaining a list of time-dependent events for a user, and audible or visible alerts are commonly employed for notifying or reminding the user of any or all of the events.

With many portable electronic devices such as cellular telephones, smart telephones, and wireless PDAs, PIM records can be created and saved using a respective PIM application of the portable electronic device. Thus, calendar data records, for example, can be created and saved using a calendar application of the portable electronic device. Similarly, contact data records can be created and saved using an address book application at the portable electronic device. PIM records can also be created and saved on another electronic device such as a desktop or laptop computer, using a PIM service application on the desktop or laptop computer. These PIM data records can be synchronized or transferred to the portable electronic device by wired or wireless connection. Thus, the PIM data records are stored at both the desktop computer and at the portable electronic device such that the PIM data records at the electronic device mirror those at the desktop computer. This permits convenient viewing of the PIM data records using the respective PIM application at either the portable electronic device or the desktop computer.

In some cases, users choose to keep different PIM data records in different PIM service accounts depending on the nature of the data record. For example a user may choose to store all business-related time-dependent events using a calendar application on the desktop computer while all personal-related time-dependent events are stored in an alternate calendar application, for example using an online PIM service account such as those offered by Google™ or Yahoo!™. Some of these online PIM service accounts permit the user to transfer PIM data records from the online PIM service account to the portable electronic device and vice versa. Other PIM service accounts may also be used such as enterprise service accounts or home computer service accounts. Unfortunately, when PIM data records are transferred from any of these services to the portable electronic device, any PIM data records already existing on the device can be deleted or the PIM data records from any one of these services are merged with any PIM data records already existing on the portable electronic device. In the example above of a user with separate business and personal calendars, for example, the business-related time-dependent event data records can be lost, or the records can be merged with the data records from the personal calendar. Similarly, contact data records stored on the portable electronic device can be lost or merged when contact data records from another PIM service account are transferred to the portable electronic device. If merged, the two sets of PIM data are displayed and are indistinguishable on the portable electronic device. Later synchronization with, for example, the desktop computer results in transfer of all personal PIM records (originating from the online PIM service account) to the desktop computer, thereby merging both personal and business related PIM data records.

It would be advantageous to improve management of storage and display of PIM data records such as time-dependent event data records and contact data records in PIM applications on the portable electronic device.

### BRIEF DESCRIPTION OF THE DRAWINGS

Embodiments of the present application will now be described, by way of example only, with reference to the attached Figures, wherein:

FIG. 1 is a block diagram of an exemplary embodiment of a portable electronic device;

FIG. 2 is an exemplary block diagram of a communication subsystem component of FIG. 1;

FIG. 3 is a block diagram of an exemplary implementation of a node of a wireless network;

FIG. 4 is a block diagram illustrating components of an exemplary configuration of a host system that the portable electronic device can communicate with;

FIG. 5 is an exemplary portable electronic device according to one embodiment;

FIG. 6 is a schematic illustration of the relationship between certain functional components of the portable electronic device including a PIM service manager and calendar and address book applications, according to one embodiment;

FIG. 7A is a flowchart illustrating steps carried out at the portable electronic device during creation and management of a PIM database;

FIG. 7B is a flowchart illustrating steps carried out at the portable electronic device during the addition of a new PIM data record to one of the PIM databases;

FIG. 8A shows a schematic illustration of the relationship between a calendar viewing application and an appointment scheduling application;

FIG. 8B shows a schematic illustration of the relationship between a contact viewing application and a contact creation/editing application;

FIG. 9 is a flowchart illustrating steps carried out at the portable electronic device during displaying of a PIM application view;

FIGS. 10 to 13 show exemplary screen shots of an LCD display of the exemplary portable electronic device of FIG. 5;

FIG. 14 is a flowchart illustrating steps carried out at the portable electronic device during managing storage of data; and

FIGS. 15 to 29 show exemplary screen shots of an LCD display in examples of the method of FIG. 14.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The embodiments described herein generally relate to portable electronic devices. Examples of portable electronic devices include mobile or handheld wireless communication devices such as pagers, cellular phones, cellular smart-phones, wireless organizers, personal digital assistants, computers, laptops, handheld wireless communication devices, wirelessly enabled notebook computers and the like.

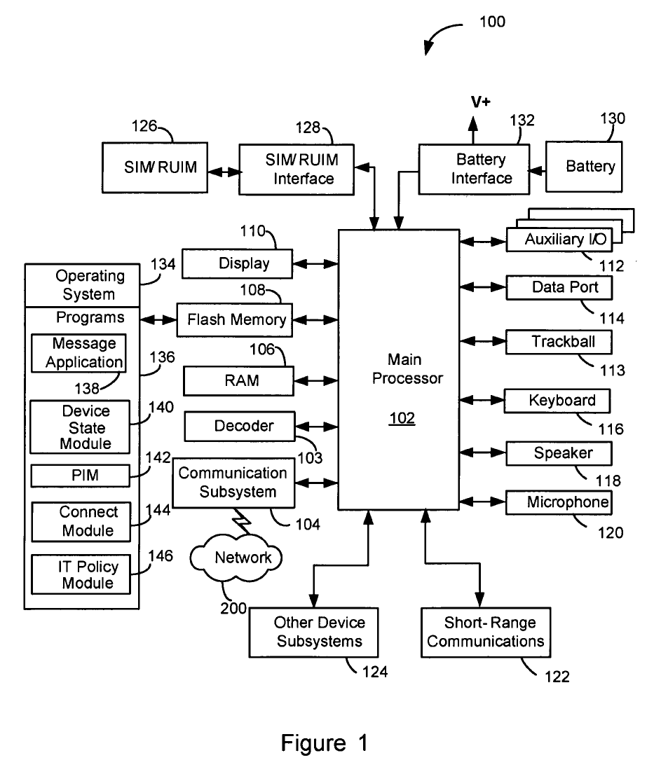

The portable electronic device may be a two-way communication device with advanced data communication capabilities including the capability to communicate with other portable electronic devices or computer systems through a network of transceiver stations. The portable electronic device may also have the capability to allow voice communication. Depending on the functionality provided by the portable electronic device, it may be referred to as a data messaging device, a two-way pager, a cellular telephone with data messaging capabilities, a wireless Internet appliance, or a data communication device (with or without telephony capabilities). To aid the reader in understanding the structure of the portable electronic device and how it communicates with other devices and host systems, reference will now be made to FIGS. 1 through 4.

Referring first to FIG. 1, shown therein is a block diagram of an exemplary embodiment of a portable electronic device 100. The portable electronic device 100 includes a number of components such as a main processor 102 that controls the overall operation of the portable electronic device 100. Communication functions, including data and voice communications, are performed through a communication subsystem 104. Data received by the portable electronic device 100 can be decompressed and decrypted by a decoder 103, operating according to any suitable decompression techniques (e.g. YK decompression, and other known techniques) and encryption techniques (e.g. using an encryption technique such as Data Encryption Standard (DES), Triple DES, or Advanced Encryption Standard (AES)). The communication subsystem 104 receives messages from and sends messages to a wireless network 200. In this exemplary embodiment of the portable electronic device 100, the communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with portable electronic device 100 is a GSM/GPRS wireless network in one exemplary implementation, other wireless networks may also be associated with the portable electronic device 100 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks such as EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems. The main processor 102 also interacts with additional subsystems such as a Random Access Memory (RAM) 106, a flash memory 108, a display 110, an auxiliary input/output (I/O) subsystem 112, a data port 114, a trackball 113, a keyboard 116, a speaker 118, a microphone 120, short-range communications 122 and other device subsystems 124.

Some of the subsystems of the portable electronic device 100 perform communication-related functions, whereas other subsystems may provide “resident” or on-device functions. By way of example, the display 110, the trackball 113 and the keyboard 116 may be used for both communication-related functions, such as entering a text message for transmission over the network 200, and device-resident functions such as a calculator or task list.

The portable electronic device 100 can send and receive communication signals over the wireless network 200 after network registration or activation procedures have been completed. Network access is associated with a subscriber or user of the portable electronic device 100. To identify a subscriber, a SIM/RUIM card 126 (i.e. Subscriber Identity Module or a Removable User Identity Module) is inserted into a SIM/RUIM interface 128 in order to communicate with a network. The SIM/RUIM card 126 is a type of a conventional “smart card” that can be used to identify a subscriber of the portable electronic device 100 and to personalize the portable electronic device 100, among other things. In the present embodiment, the portable electronic device 100 is not fully operational for communication with the wireless network 200 without the SIM/RUIM card 126. By inserting the SIM/RUIM card 126 into the SIM/RUIM interface 128, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 126 includes a processor and memory for storing information. Once the SIM card/RUIM 126 is inserted into the SIM/RUIM interface 128, it is coupled to the main processor 102. In order to identify the subscriber, the SIM card/RUIM 126 can include some user parameters such as an International Mobile Subscriber Identity (IMSI). An advantage of using the SIM card/RUIM 126 is that a subscriber is not necessarily bound by any single physical portable electronic device. The SIM card/RUIM 126 may store additional subscriber information for a portable electronic device as well, including datebook (or calendar) information and recent call information. Alternatively, user identification information can also be programmed into the flash memory 108.

The portable electronic device 100 is a battery-powered device and includes a battery interface 132 for receiving one or more rechargeable batteries 130. In at least some embodiments, the battery 130 can be a smart battery with an embedded microprocessor. The battery interface 132 is coupled to a regulator (not shown), which assists the battery 130 in providing power V+ to the portable electronic device 100. Although current technology makes use of a battery, future technologies such as micro fuel cells may provide the power to the portable electronic device 100.

The portable electronic device 100 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications are installed on the portable electronic device 100 during its manufacture. Other software applications include a message application 138 that can be any suitable software program that allows a user of the portable electronic device 100 to send and receive electronic messages. Various alternatives exist for the message application 138 as is well known to those skilled in the art. Messages that have been sent or received by the user are typically stored in the flash memory 108 of the portable electronic device 100 or some other suitable storage element in the portable electronic device 100. In at least some embodiments, some of the sent and received messages may be stored remotely from the device 100 such as in a data store of an associated host system that the portable electronic device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the portable electronic device 100 is turned off or loses power.

The PIM 142 includes functionality for organizing and managing data items of interest to the user, such as, but not limited to, e-mail, contacts, calendar events, voice mails, appointments, and task items. PIM applications include, for example, calendar, address book, tasks and memo applications. The PIM applications have the ability to send and receive data items via the wireless network 200. PIM data items may be seamlessly integrated, synchronized, and updated via the wireless network 200 with the portable electronic device subscriber's corresponding data items stored and/or associated with a host computer system. This functionality creates a mirrored host computer on the portable electronic device 100 with respect to such items. This can be particularly advantageous when the host computer system is the portable electronic device subscriber's office computer system.

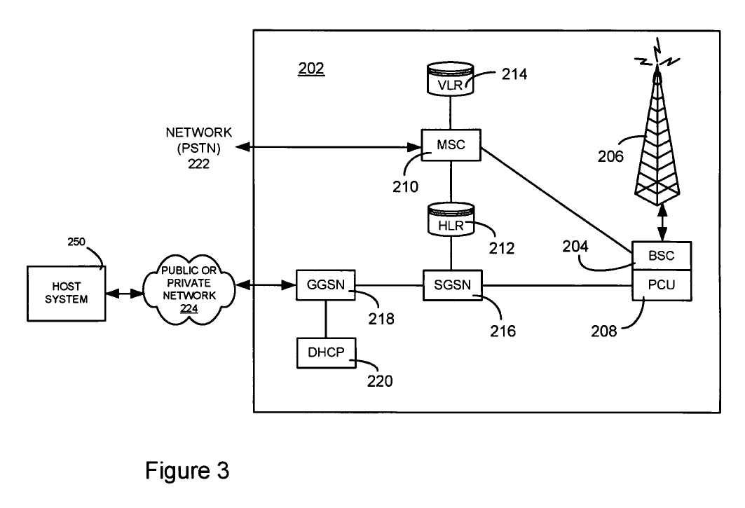

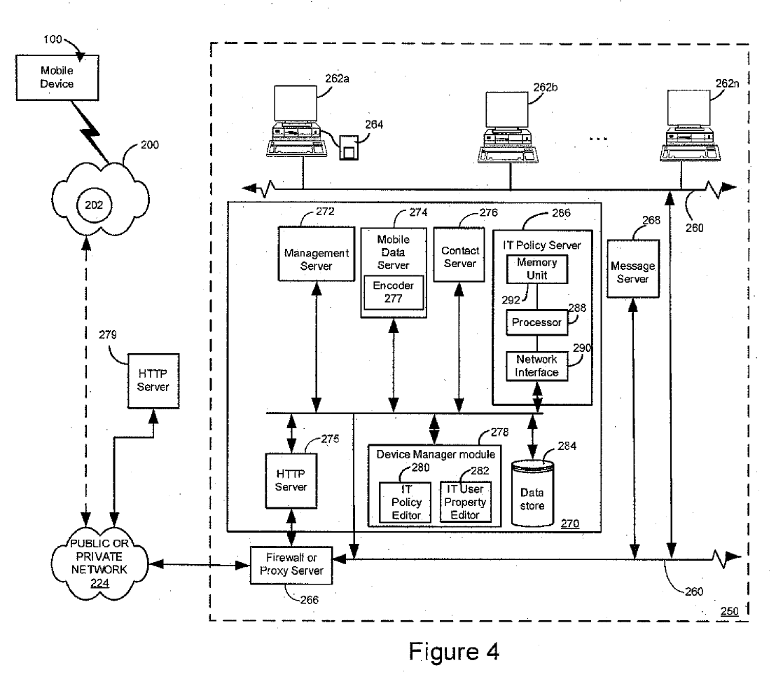

The portable electronic device 100 also includes a connect module 144, and an information technology (IT) policy module 146. The connect module 144 implements the communication protocols that are required for the portable electronic device 100 to communicate with the wireless infrastructure and any host system, such as an enterprise system, that the portable electronic device 100 is authorized to interface with. Examples of a wireless infrastructure and an enterprise system are given in FIGS. 3 and 4, which are described in more detail below.

The connect module 144 includes a set of APIs that can be integrated with the portable electronic device 100 to allow the portable electronic device 100 to use any number of services associated with the enterprise system. The connect module 144 allows the portable electronic device 100 to establish an end-to-end secure, authenticated communication pipe with the host system. A subset of applications for which access is provided by the connect module 144 can be used to pass IT policy commands from the host system to the portable electronic device 100. This can be done in a wireless or wired manner. These instructions can then be passed to the IT policy module 146 to modify the configuration of the device 100. Alternatively, in some cases, the IT policy update can also be done over a wired connection.

Other types of software applications can also be provided on the portable electronic device 100 and still others can be installed on the portable electronic device 100. Such software applications can be third party applications, which are added after the manufacture of the portable electronic device 100. Examples of third party applications include games, calculators, utilities, etc.

The additional applications can be loaded onto the portable electronic device 100 through at least one of the wireless network 200, the auxiliary I/O subsystem 112, the data port 114, the short-range communications subsystem 122, or any other suitable device subsystem 124. This flexibility in application installation increases the functionality of the portable electronic device 100 and may provide enhanced on-device functions, communication-related functions, or both. For example, secure communication applications may enable electronic commerce functions and other such financial transactions to be performed using the portable electronic device 100.

The data port 114 enables a subscriber to set preferences through an external device or software application and extends the capabilities of the portable electronic device 100 by providing for information or software downloads to the portable electronic device 100 other than through a wireless communication network. The alternate download path may, for example, be used to load an encryption key onto the portable electronic device 100 through a direct and thus reliable and trusted connection to provide secure device communication.

The data port 114 can be any suitable port that enables data communication between the portable electronic device 100 and another computing device. The data port 114 can be a serial or a parallel port. In some instances, the data port 114 can be a USB port that includes data lines for data transfer and a supply line that can provide a charging current to charge the battery 130 of the portable electronic device 100.

The short-range communications subsystem 122 provides for communication between the portable electronic device 100 and different systems or devices, without the use of the wireless network 200. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, Web page download, or any other information is processed by the communication subsystem 104 and input to the main processor 102. The main processor 102 will then process the received signal for output to the display 110 or alternatively to the auxiliary I/O subsystem 112. A subscriber may also compose data items, such as e-mail messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, or a roller wheel with dynamic button pressing capability. The keyboard 116 is preferably an alphanumeric keyboard and/or telephone-type keypad. However, other types of keyboards may also be used. A composed item may be transmitted over the wireless network 200 through the communication subsystem 104.

For voice communications, the overall operation of the portable electronic device 100 is substantially similar, except that the received signals are output to the speaker 118, and signals for transmission are generated by the microphone 120. Alternative voice or audio I/O subsystems, such as a voice message recording subsystem, can also be implemented on the portable electronic device 100. Although voice or audio signal output is accomplished primarily through the speaker 118, the display 110 can also be used to provide additional information such as the identity of a calling party, duration of a voice call, or other voice call related information.

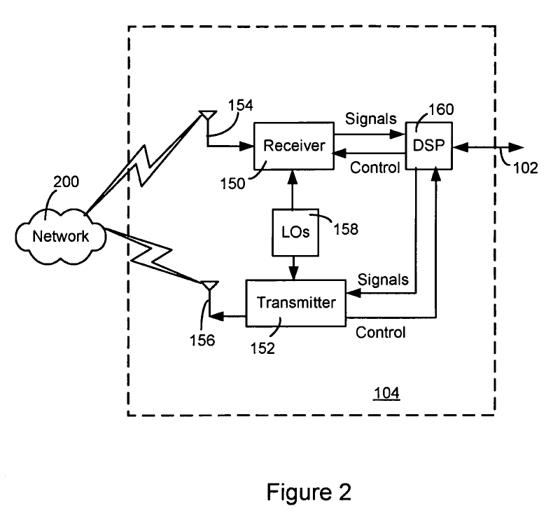

Referring now to FIG. 2, an exemplary block diagram of the communication subsystem component 104 is shown. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160. The particular design of the communication subsystem 104 is dependent upon the communication network 200 with which the portable electronic device 100 is intended to operate. Thus, it should be understood that the design illustrated in FIG. 2 serves only as one example.

Signals received by the antenna 154 through the wireless network 200 are input to the receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 160. In a similar manner, signals to be transmitted are processed, including modulation and encoding, by the DSP 160. These DSP-processed signals are input to the transmitter 152 for digital-to-analog (D/A) conversion, frequency up conversion, filtering, amplification and transmission over the wireless network 200 via the antenna 156. The DSP 160 not only processes communication signals, but also provides for receiver and transmitter control. For example, the gains applied to communication signals in the receiver 150 and the transmitter 152 may be adaptively controlled through automatic gain control algorithms implemented in the DSP 160.

The wireless link between the portable electronic device 100 and the wireless network 200 can contain one or more different channels, typically different RF channels, and associated protocols used between the portable electronic device 100 and the wireless network 200. An RF channel is a limited resource that should be conserved, typically due to limits in overall bandwidth and limited battery power of the portable electronic device 100.

When the portable electronic device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

Referring now to FIG. 3, a block diagram of an exemplary implementation of a node 202 of the wireless network 200 is shown. In practice, the wireless network 200 comprises one or more nodes 202. In conjunction with the connect module 144, the portable electronic device 100 can communicate with the node 202 within the wireless network 200. In the exemplary implementation of FIG. 3, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable portable electronic devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the portable electronic device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from portable electronic devices within its cell via the station 206. The fixed transceiver equipment normally performs such functions as modulation and possibly encoding and/or encryption of signals to be transmitted to the portable electronic device 100 in accordance with particular, usually predetermined, communication protocols and parameters, under control of its controller. The fixed transceiver equipment similarly demodulates and possibly decodes and decrypts, if necessary, any communication signals received from the portable electronic device 100 within its cell. Communication protocols and parameters may vary between different nodes. For example, one node may employ a different modulation scheme and operate at different frequencies than other nodes.

For all portable electronic devices 100 registered with a specific network, permanent configuration data such as a user profile is stored in the HLR 212. The HLR 212 also contains location information for each registered portable electronic device and can be queried to determine the current location of a portable electronic device. The MSC 210 is responsible for a group of location areas and stores the data of the portable electronic devices currently in its area of responsibility in the VLR 214. Further, the VLR 214 also contains information on portable electronic devices that are visiting other networks. The information in the VLR 214 includes part of the permanent portable electronic device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each portable electronic device 100. The SGSN 216 also performs security functions and access control for data traffic on the wireless network 200. The GGSN 218 provides internetworking connections with external packet switched networks and connects to one or more SGSN's 216 via an Internet Protocol (IP) backbone network operated within the network 200. During normal operations, a given portable electronic device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a portable electronic device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each portable electronic device 100 must be assigned to one or more APNs and portable electronic devices 100 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a portable electronic device 100 is not using its PDP Context, the PDP Context can be de-allocated and the IP address returned to the IP address pool managed by the DHCP server 220.

Referring now to FIG. 4, shown therein is a block diagram illustrating components of an exemplary configuration of a host system 250 that the portable electronic device 100 can communicate with in conjunction with the connect module 144. The host system 250 will typically be a corporate enterprise or other local area network (LAN), but may also be a home office computer or some other private system, for example, in variant implementations. In this example shown in FIG. 4, the host system 250 is depicted as a LAN of an organization to which a user of the portable electronic device 100 belongs. Typically, a plurality of portable electronic devices can communicate wirelessly with the host system 250 through one or more nodes 202 of the wireless network 200.

The host system 250 comprises a number of network components connected to each other by a network 260. For instance, a user's desktop computer 262a with an accompanying cradle 264 for the user's portable electronic device 100 is situated on a LAN connection. The cradle 264 for the portable electronic device 100 can be coupled to the computer 262a by a serial or a Universal Serial Bus (USB) connection, for example. Other user computers 262b-262n are also situated on the network 260, and each may or may not be equipped with an accompanying cradle 264. The cradle 264 facilitates the loading of information (e.g. PIM data, private symmetric encryption keys to facilitate secure communications) from the user computer 262a to the portable electronic device 100, and may be particularly useful for bulk information updates often performed in initializing the portable electronic device 100 for use. The information downloaded to the portable electronic device 100 may include certificates used in the exchange of messages.

It will be understood by persons skilled in the art that the user computers 262a-262n will typically also be connected to other peripheral devices, such as printers, etc. which are not explicitly shown in FIG. 4. Furthermore, only a subset of network components of the host system 250 are shown in FIG. 4 for ease of exposition, and it will be understood by persons skilled in the art that the host system 250 will comprise additional components that are not explicitly shown in FIG. 4 for this exemplary configuration. More generally, the host system 250 may represent a smaller part of a larger network (not shown) of the organization, and may comprise different components and/or be arranged in different topologies than that shown in the exemplary embodiment of FIG. 4.

To facilitate the operation of the portable electronic device 100 and the wireless communication of messages and message-related data between the portable electronic device 100 and components of the host system 250, a number of wireless communication support components 270 can be provided. In some implementations, the wireless communication support components 270 can include a management server 272, a mobile data server (MDS) 274, a web server, such as Hypertext Transfer Protocol (HTTP) server 275, a contact server 276, and a device manager module 278. HTTP servers can also be located outside the enterprise system, as indicated by the HTTP server 275 attached to the network 224. The device manager module 278 includes an IT Policy editor 280 and an IT user property editor 282, as well as other software components for allowing an IT administrator to configure the portable electronic devices 100. In an alternative embodiment, there may be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the portable electronic devices 100. The memory unit 292 can store functions used in implementing the IT policy as well as related data. Those skilled in the art know how to implement these various components. Other components may also be included as is well known to those skilled in the art. Further, in some implementations, the data store 284 can be part of any one of the servers.

In this exemplary embodiment, the portable electronic device 100 communicates with the host system 250 through node 202 of the wireless network 200 and a shared network infrastructure 224 such as a service provider network or the public Internet. Access to the host system 250 may be provided through one or more routers (not shown), and computing devices of the host system 250 may operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the portable electronic device 100. The wireless VPN router allows a VPN connection to be established directly through a specific wireless network to the portable electronic device 100. The wireless VPN router can be used with the Internet Protocol (IP) Version 6 (IPV6) and IP-based wireless networks. This protocol can provide enough IP addresses so that each portable electronic device has a dedicated IP address, making it possible to push information to a portable electronic device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the portable electronic device 100 in this alternative implementation.

Messages intended for a user of the portable electronic device 100 are initially received by a message server 268 of the host system 250. Such messages may originate from any number of sources. For instance, a message may have been sent by a sender from the computer 262b within the host system 250, from a different portable electronic device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly e-mail messages, within the organization and over the shared network infrastructure 224. Each user in the organization that has been set up to send and receive messages is typically associated with a user account managed by the message server 268. Some exemplary implementations of the message server 268 include a Microsoft Exchange™ server, a Lotus Domino server, a Novell Groupwise™ server, or another suitable mail server installed in a corporate environment. In some implementations, the host system 250 may comprise multiple message servers 268. The message server provides additional functions including PIM functions such as calendaring, contacts and tasks and supports data storage.

When messages are received by the message server 268, they are typically stored in a data store associated with the message server 268. In at least some embodiments, the data store may be a separate hardware unit, such as data store 284, that the message server 268 communicates with. Messages can be subsequently retrieved and delivered to users by accessing the message server 268. For instance, an e-mail client application operating on a user's computer 262a may request the e-mail messages associated with that user's account stored on the data store associated with the message server 268. These messages are then retrieved from the data store and stored locally on the computer 262a. The data store associated with the message server 268 can store copies of each message that is locally stored on the portable electronic device 100. Alternatively, the data store associated with the message server 268 can store all of the messages for the user of the portable electronic device 100 and only a smaller number of messages can be stored on the portable electronic device 100 to conserve memory. For instance, the most recent messages (i.e. those received in the past two to three months for example) can be stored on the portable electronic device 100.

When operating the portable electronic device 100, the user may wish to have e-mail messages retrieved for delivery to the portable electronic device 100. The message application 138 operating on the portable electronic device 100 may also request messages associated with the user's account from the message server 268. The message application 138 may be configured (either by the user or by an administrator, possibly in accordance with an organization's IT policy) to make this request at the direction of the user, at some pre-defined time interval, or upon the occurrence of some pre-defined event. In some implementations, the portable electronic device 100 is assigned its own e-mail address, and messages addressed specifically to the portable electronic device 100 are automatically redirected to the portable electronic device 100 as they are received by the message server 268.

The management server 272 can be used to specifically provide support for the management of, for example, messages, such as e-mail messages, that are to be handled by portable electronic devices. Generally, while messages are still stored on the message server 268, the management server 272 can be used to control when, if, and how messages are sent to the portable electronic device 100. The management server 272 also facilitates the handling of messages composed on the portable electronic device 100, which are sent to the message server 268 for subsequent delivery.

For example, the management server 272 may monitor the user's “mailbox” (e.g. the message store associated with the user's account on the message server 268) for new e-mail messages, and apply user-definable filters to new messages to determine if and how the messages are relayed to the user's portable electronic device 100. The management server 272 may also, through an encoder 273, compress messages, using any suitable compression technology (e.g. YK compression, and other known techniques) and encrypt messages (e.g. using an encryption technique such as Data Encryption Standard (DES), Triple DES, or Advanced Encryption Standard (AES)), and push them to the portable electronic device 100 via the shared network infrastructure 224 and the wireless network 200. The management server 272 may also receive messages composed on the portable electronic device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the portable electronic device 100 can be defined (e.g. by an administrator in accordance with IT policy) and enforced by the management server 272. These may include whether the portable electronic device 100 may receive encrypted and/or signed messages, minimum encryption key sizes, whether outgoing messages must be encrypted and/or signed, and whether copies of all secure messages sent from the portable electronic device 100 are to be sent to a pre-defined copy address, for example.

The management server 272 may also be adapted to provide other control functions, such as only pushing certain message information or pre-defined portions (e.g. “blocks”) of a message stored on the message server 268 to the portable electronic device 100. For example, in some cases, when a message is initially retrieved by the portable electronic device 100 from the message server 268, the management server 272 may push only the first part of a message to the portable electronic device 100, with the part being of a pre-defined size (e.g. 2 KB). The user can then request that more of the message be delivered in similar-sized blocks by the management server 272 to the portable electronic device 100, possibly up to a maximum pre-defined message size. Accordingly, the management server 272 facilitates better control over the type of data and the amount of data that is communicated to the portable electronic device 100, and can help to minimize potential waste of bandwidth or other resources.

The MDS 274 encompasses any other server that stores information that is relevant to the corporation. The mobile data server 274 may include, but is not limited to, databases, online data document repositories, customer relationship management (CRM) systems, or enterprise resource planning (ERP) applications. The MDS 274 can also connect to the Internet or other public network, through HTTP server 275 or other suitable web server such as an File Transfer Protocol (FTP) server, to retrieve HTTP webpages and other data. Requests for webpages are typically routed through MDS 274 and then to HTTP server 275, through suitable firewalls and other protective mechanisms. The web server then retrieves the webpage over the Internet, and returns it to MDS 274. As described above in relation to management server 272, MDS 274 is typically provided, or associated, with an encoder 277 that permits retrieved data, such as retrieved webpages, to be compressed, using any suitable compression technology (e.g. YK compression, and other known techniques), and encrypted (e.g. using an encryption technique such as DES, Triple DES, or AES), and then pushed to the portable electronic device 100 via the shared network infrastructure 224 and the wireless network 200.

The contact server 276 can provide information for a list of contacts for the user in a similar fashion as the address book on the portable electronic device 100. Accordingly, for a given contact, the contact server 276 can include the name, phone number, work address and e-mail address of the contact, among other information. The contact server 276 can also provide a global address list that contains the contact information for all of the contacts associated with the host system 250.

It will be understood by persons skilled in the art that the management server 272, the MDS 274, the HTTP server 275, the contact server 276, the device manager module 278, the data store 284 and the IT policy server 286 do not need to be implemented on separate physical servers within the host system 250. For example, some or all of the functions associated with the management server 272 may be integrated with the message server 268, or some other server in the host system 250. Alternatively, the host system 250 may comprise multiple management servers 272, particularly in variant implementations where a large number of portable electronic devices need to be supported.

The device manager module 278 provides an IT administrator with a graphical user interface with which the IT administrator interacts to configure various settings for the portable electronic devices 100. As mentioned, the IT administrator can use IT policy rules to define behaviors of certain applications on the portable electronic device 100 that are permitted such as phone, web browser or Instant Messenger use. The IT policy rules can also be used to set specific values for configuration settings that an organization requires on the portable electronic devices 100 such as auto signature text, WLAN/VoIP/VPN configuration, security requirements (e.g. encryption algorithms, password rules, etc.), specifying themes or applications that are allowed to run on the portable electronic device 100, and the like.

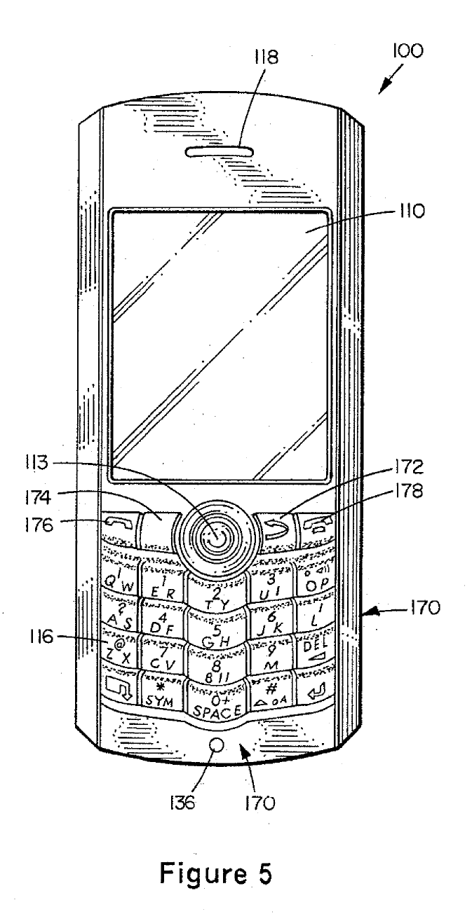

Reference is now made to FIG. 5, which shows an exemplary portable electronic device 100 in accordance with an embodiment. It will be appreciated that the present application is not limited to the portable electronic device 100 shown in FIG. 5 and many other portable electronic devices are possible as indicated hereinabove. The portable electronic device 100 includes a housing 170 that frames the LCD display 110, the speaker 118, the trackball 113, the keyboard 116, and the microphone 136. The trackball 113 can be rolled within a socket for user-input and can be inwardly depressed as a means for providing additional user-input. The keyboard 116 includes input keys such as an exit key 172, a menu key 174, an initiate call key 176 and an end call key 178. The housing 170 is made from a suitable material as will occur to those skilled in the art and can be stored, for example, in a holster (not shown) that includes an attachment for attaching to a user's belt.

A method of managing storage of data at an electronic device such as the portable electronic device 100 includes maintaining databases associated with respective PIM service accounts including at least a first database associated with a first PIM service account and a second database associated with a second PIM service account, receiving a user-selected option to save a data record stored in the first database to the second database, and storing the record in the second database.

As indicated above, the portable electronic device includes the Personal Information Manager (PIM) 142 that includes functionality for organizing and managing data items of interest to the user, such as, but not limited to, e-mail, contacts, calendar events, voice mails, appointments, and task items. PIM applications include, for example, calendar, address book, tasks and memo applications.

The address book applications provide a graphical user interface for creating, viewing and managing address book data including contacts names, addresses, email addresses, telephone numbers, and other information when executed by the processor 102.

It will also be appreciated that the calendar applications are used for displaying and storing time-dependent events such as appointments, lectures, exams, movies, meetings, performances, dinners, ceremonies, etc., when executed by the processor 102. Each calendared event includes a variety of information including a date and time of the event.

The profiles application is used for selection and customization of notification modes by user selection from a number of different notifications set for the occurrence of specific events. Each profile can be customized to give rise to different notification output for various applications on the portable electronic device 100.

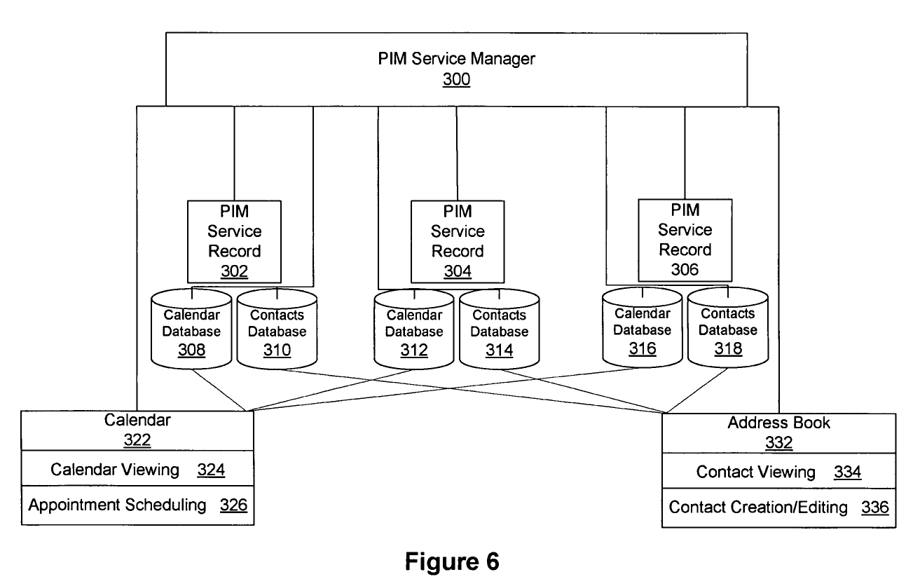

Referring now to FIG. 6, the persistent store, which in the present embodiment is the flash memory 108, includes the applications software referred to above such as the PIM 142 (shown in FIG. 1), which includes a PIM service manager application 300. The PIM service manager application 300 begins on startup of the portable electronic device 100 and, in the present embodiment, runs in the background on the portable electronic device 100. The PIM service manager application 300 is responsible for receiving service record changes including additions, modifications and deletions, for maintaining and managing databases for storage of PIM data records including time-dependent event data records and contact data records and for managing connections to different PIM services.

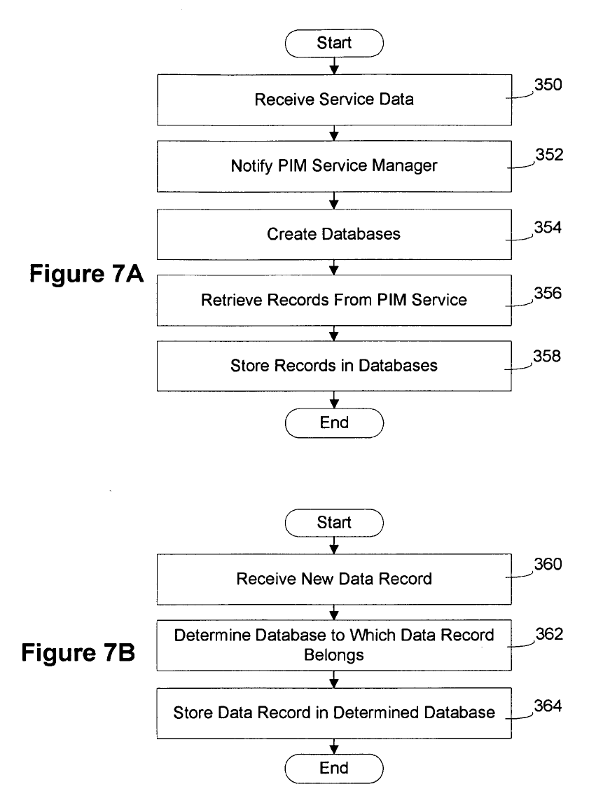

Referring now to FIG. 7A, there is shown a flowchart illustrating steps carried out at the portable electronic device 100 during the creation and management of new databases associated with a new PIM service account. A PIM service record, such as the exemplary PIM service records 302, 304, 306 shown in FIG. 6, is created any time a new PIM service is provisioned on the portable electronic device 100. The PIM service records are contained within service books (not depicted). In other words, when a new PIM service is added (also referred to herein as provisioned) to enable viewing and storage of PIM data records such as time-dependent event data records or contact data records on the portable electronic device 100, a PIM service record is created. A data packet is received at the portable electronic device 100 including information about a PIM service that is parsed to create the service record (step 350). The PIM service record includes information from the data packet such as, for example, a unique identifier of the server (SSRPID), a datasource identifier or address of where the user's data is stored on the server with which it is associated (datasourceID), a unique identifier, identifying the user on the server (userID), and the capabilities. Thus, the PIM service, the location of the user's PIM records and the user's identification are all received in the PIM service record. The PIM service record information is used to create a unique service identification for uniquely identifying each PIM service and for tagging the associated data for identification of the PIM service to which it belongs (the PIM service that the data is sent/received from or stored in. For certain PIM services some data such as a User ID may not be available and certain data may be created at the portable electronic device 100 for identification purposes. The unique service identification can be created many different ways, for example, using any suitable one of or a combination of hashing, bit shifting and concatenating operations. The unique service identification is created such that for each PIM service the same unique service identification is always created. Thus, for example, if a user deregisters from a PIM service and later re-registers the same PIM service on the portable electronic device 100 (provisions the PIM service again), the same unique service identification is created. When the user de-registers from a service, data remains on the device portable electronic device 100. The data is later determined to be associated with the “new” PIM service record that is created when the user again provisions the PIM service on the portable electronic device. Thus, the PIM data records stored on the device are associated with the correct PIM service record. The capabilities include information for data exchange with the calendar service such as, routing information, content types and synchronization capability (pull capability only or full synchronization capability). From the information in the PIM service record, a notification is sent to the PIM service manager application 300 in the form of an addition, update or removal. In the case of an addition of a PIM service, an addition notification is sent to the PIM service manager application (step 352) from the service book.

The PIM service manager application 300 acts as an intermediary or middle manager by managing the PIM services for the PIM applications including the calendar applications and the address book applications, for example. The PIM service manager application 300 uses the information embedded in the notification from step 352 to create the databases (step 354) and initiates retrieval of the PIM records from the PIM service based on the synchronization capabilities defined in the PIM service record (step 356). The PIM data records are then stored in the appropriate database (step 358). In the present example, as shown in FIG. 6, two databases are shown for each PIM service record, including a calendar database and a contacts database. Thus time-dependent event data records are stored in the appropriate calendar database and contact data records are stored in the appropriate contacts database (step 358). Thus, the PIM service manager application 300 creates new databases, such as the exemplary databases 308, 310, 312, 314, 316, 318 shown in FIG. 6, when a new PIM service is added, for storage of PIM data records from the new PIM service. For example, a new calendar database is added for storage of new time-dependent event data records in the form of Java-based objects for example. Similarly, a new contacts database is added for storage of new contact data records. Throughout the present description, reference is made to time-dependent events and to contacts. It will be understood that the time-dependent events and contacts as referred to throughout the description are time-dependent event data records and contact data records, respectively. It will also be appreciated that where PIM data records including time-dependent events and contacts are referred to in relation to a PIM service, the PIM data records are data such as Java-based objects. The PIM databases are associated with the PIM service by the PIM service record and only PIM data records that belong to that PIM service are stored in the associated databases. Thus, time-dependent events (time-dependent event data records) that belong to a PIM service are stored in the associated calendar database and contacts (contact data records) that belong to that PIM service are stored in the associated contacts database. Thus, for each PIM service, a PIM service record is created along with databases, including, for example, a calendar database and a contacts database. The PIM service manager application 300 notifies the calendar application of the addition of a new PIM service. Similarly, the PIM service manager application 300 notifies the address book application of the addition of a new PIM service.

In the exemplary embodiment shown in FIG. 6, three PIM service records 302, 304, 306 are shown, each with two associated PIM record databases, including an associated calendar database and an associated contacts database. Thus, there are three calendar databases 308, 312, 316, each associated with a respective one of the PIM service records 302, 304, 306. Similarly, there are three contacts databases 310, 314, 318, each associated with a respective one of the PIM service records 302, 304, 306. The time-dependent events and the address book contacts from three different PIM services are stored on the portable electronic device 100 for viewing by the user. It will be appreciated that three PIM service records 302, 304, 306 and associated databases 308, 310, 312, 314, 316, 318 are shown for exemplary purposes only, and the portable electronic device 100 is not limited to three calendar services or three contacts databases. A greater or lesser number of PIM services (and associated PIM service records and databases) is possible. Any suitable PIM service can be added to enable viewing and storage of PIM data records such as time-dependent events or contacts on the portable electronic device 100. For example PIM services can be online PIM services, enterprise PIM services such as, for example, the host computer system 250 described above, or home PIM services.

It will be appreciated that time-dependent events in the form of, for example, appointments can be added to the calendar databases 308, 312, 316 in different ways such as by synchronization with a PIM service account from the host system 250, or with an online PIM service as referred to above with reference to steps 356 and 358 of FIG. 7A, or, for example, by receipt of an email containing a meeting attachment. Similarly, contacts can be added to the contacts databases 310, 314, 318 in different ways such as by synchronization with a PIM service account from the host system 250, or with an online PIM service or by receipt of an email containing a contact attachment. The synchronization capability for a PIM service is defined in the PIM service record. The time-dependent events or the contacts of an online PIM service can be added to the portable electronic device 100, for example, and therefore the synchronization capability of that online PIM service is defined. The online PIM service can, for example, publish a URL (step 350) permitting the user to pull the PIM data records to the portable electronic device 100. It is possible that the PIM data records can only be pulled to the portable electronic device 100 and synchronization is not permitted by the online PIM service. Thus, this capability is defined in the PIM service record that is created at step 352, and a rule is set up in the PIM service record to pull time-dependent events from the calendar service at suitable time intervals, for example, on an hourly or daily basis. A unique service identification is created as referred to above and the PIM service manager application 300 creates associated databases at step 354 and uses the rule to retrieve the PIM data records including time-dependent events and contacts by performing an HTTP GET request (step 356). The data is parsed upon receipt at the portable electronic device, and the parsed data is added to the databases created for the respective PIM records from that PIM service (step 358).

It will be appreciated that other PIM service accounts may allow data records to be added to the PIM service so that a partial synchronization is permitted in that PIM data records added to the portable electronic device 100 can be added to the PIM service account. In yet another alternative, a PIM service account may allow for full synchronization such that PIM data records added to the portable electronic device 100 can be added to the PIM service account and PIM data records deleted from the portable electronic device 100 are deleted from the PIM service account.

As indicated above, PIM data records can also be added by, for example, receipt of an email with an electronic meeting attachment or receipt of an email with a contact attached. Referring to FIG. 7B, a new PIM record such as a time-dependent event is received at the portable electronic device 100 at step 360. The PIM data record is determined by the PIM service manager application 300 to be associated with a PIM service for which a database exists on the portable electronic device 100, using information such as the unique service identification (step 362). The PIM data record is then parsed and stored in the appropriate database at step 364 (stored in the database determined at step 362 to be associated with PIM service). In one particular example, an online PIM service including email is set up and used for the portable electronic device 100 to receive email from and to store time-dependent events and contacts of. In this case, the unique service identification for the PIM service applications including email, calendar and address book, are the same. When a meeting request (calendar event data record) is received at the portable electronic device 100 via email (step 360), the unique service identification is determined by the PIM service manager application 300 to be associated with a PIM service for which the portable electronic device 100 includes a database, such as the database 308 (step 362). The meeting request (calendar event data record) is then parsed and is stored in the database 308 based on the unique service identification (step 364). Similarly, when a contact is received at the portable electronic device 100 via email (step 360), the unique service identification is determined by the PIM service manager application 300 to be associated with a PIM service for which the portable electronic device 100 includes a database, such as the database 310 (step 362). The contact is then parsed and is stored in the contacts database 310 based on the unique service identification (step 364).

It will be appreciated that time-dependent events can also be added to any one of the calendar databases 308, 312, 316 in many other ways. For example, a time-dependent event can be added by user creation of the appointment using an appointment scheduling application as referred to below. Further, the user can select which PIM service to send the appointment invitation from, thereby determining which calendar database to store the new time-dependent event in. Similarly, contacts can be added to any one of the contacts databases 310, 314, 318 in many other ways. Further, the user can select which of the contacts databases to save a new contact in when creating a contact on the portable electronic device 100.

It will also be appreciated that when a PIM data record is modified on the device by editing one of the user-editable fields in, for example, the calendar application or the address book application, the PIM data record is stored in the appropriate one of the databases 308, 312, 316, 310, 314, 318 at the portable electronic device 100. The database in which the PIM data record is stored is associated with a PIM service account by the respective one of the PIM service records 302, 304, 306. Where synchronization capabilities permit, the portable electronic device 100 can then send an update to the associated PIM service account to reflect the changes made to the PIM data record by the user of the portable electronic device 100.

Based on the foregoing, it will be appreciated that PIM data records from more than one PIM service account can be managed and stored on the portable electronic device 100 in respective PIM databases. Thus, time-dependent events from more than one PIM service account can be managed and stored on the portable electronic device 100 in respective calendar databases, each calendar database being dedicated to a respective PIM service account. Similarly, contacts from more than one PIM service account can be managed and stored on the portable electronic device 100 in respective contacts databases, each contacts database being dedicated to a respective PIM service account.

The display of time-dependent events from multiple databases will now be described with reference to FIGS. 6 and 8A. The calendar applications 322 include both a calendar-viewing application 324 and an appointment-scheduling application 326. The calendar-viewing application 324 is responsible for displaying time-dependent event information in any one of the calendar views, including day view, week view or month view, selectable by the user. The calendar-viewing application 324 is operable to display time-dependent event information based on time-dependent events stored in multiple calendar databases. In the present example, three calendar databases 308, 312, 316 exist for storing time-dependent events based on the PIM services to which the time-dependent event belongs although the present application is not limited to three calendar databases and further databases can exist.

The appointment-scheduling application 326 is for creating and scheduling time-dependent events for display using the calendar viewing function. Time-dependent events that are scheduled are stored in one of the calendar databases 308, 312, 316, either a default database or a database selectable by the user.

FIG. 8A is a schematic illustration of the relationship between the calendar viewing application 324 and the appointment scheduling application 326. As shown in FIG. 8A, the exemplary calendar databases 308, 312, 316 are functionally connected to both the calendar viewing application 324 and the appointment scheduling application 326 to facilitate the addition, deletion and modification of appointment data using the appointment scheduling application 326 and to facilitate the display of appointment data from different calendar databases in the same view.

Functional features of the calendar viewing application 324 include a calendar viewer 328 and a time-based collector 330. The calendar viewer 328 in the present embodiment is in the form of a software module that is responsible for displaying a graphical user interface (GUI) via the LCD display 110 for a user of the portable electronic device 100. The GUI provides different display options for user selection including the selection of different views, such as day view, week view, and month view. Other views are possible. The display options also permit user selection of the calendar database(s) for viewing, thereby allowing the user to select from the existing calendar databases for viewing, as will be explained further below.

The time-based collector 330 is also in the form of a software module in the present embodiment and is responsible for providing a list of time-dependent events to the calendar viewer 328 for display. The list is provided by the time-based collector 330 in response to a request from the calendar viewer 328 for time-dependent events in any or all of the calendar databases 308, 312, 316 that meet specified constraints. The constraints include, for example, a start time that falls within a specified range dependent on the calendar view selected for display and displayed using the calendar viewer 328. The time-dependent events in the list include only those time-dependent events from the calendar databases 308, 312, 316 selected for viewing by the user. If, for example, the user selects all of the calendar databases 308, 312, 316 for display, all time-dependent events having a start time that falls within the specified range from all of the calendar databases 308, 312, 316 are displayed in a single display.

The appointment scheduling application 326 is also responsible for displaying a GUI via the LCD display 110 for a user of the portable electronic device 100. This GUI is for creating and scheduling time-dependent events and permits user creation, modification and deletion of time-dependent events including information by user entry into fields such as the start time, duration, location and time zone for a time-dependent event data record. The appointment scheduling application 326 permits user-selection of which of the calendar databases 308, 312, 316 a new appointment is added to. Thus, the user can add to any one of the calendar databases 308, 312, 316 by selecting the database for storage of a new calendar event data record during creation of the data record.

The calendar viewer 328 is responsible for displaying a calendar GUI to the LCD display 100 and updating the LCD display 100 in response to user interactions with the GUI such as setting a particular calendar view and selecting ones of the calendar databases 308, 312, 316 to be included in the display. In order to display time-dependent events in a specific time period, the calendar viewer 328 receives a calendar-view selection by user input using, for example, the trackball 113, thereby indicating which of the calendar views the user wishes to have displayed on the LCD display 110. If no calendar view is selected by the user a default calendar view is used. The calendar viewer 328 requests from the time-based collector 330 a list of time-dependent events that begin within the time period shown in the calendar view. When received from the time-based collector 330, the calendar viewer 328 causes each time-based event data record to be rendered in the proper location within the displayed calendar view, based on the start time and duration of the appointment.

The time-based collector 330 is responsible for time-based collection of time-dependent events based on the request received from the calendar viewer 328. Thus, the time-based collector 330 returns a list of time-dependent events from all of the selected calendar databases 308, 312, 316 that fall within the constraints defined in the request. The list of time-dependent events is ordered and provided to the calendar viewer 328 for rendering. The time-based collector 330 also includes a cache for storage of recently collected lists.

The display of contacts is similar to the display of time-dependent events and contacts. Referring to FIGS. 6 and 8B, the address book applications 332 include both a contact-viewing application 334 and a contact creation/editing application 336. The contact-viewing application 334 is responsible for displaying contact information in an address book view selectable by the user. The address book application 334 is operable to display contact information based on contacts stored in multiple contacts databases. In the present example, three contacts databases 310, 314, 318 are provisioned for storing contacts based on the PIM service to which the contact belongs although the present application is not limited to three contacts databases and further databases can exist.

The contact creation/editing application 336 is for creating and editing contacts for display using the contact viewing function. Contacts that are created are stored in one of the contacts databases 310, 314, 318, either a default database or a database selectable by the user.

FIG. 8B is a schematic illustration of the relationship between the contact viewing application 334 and the contact creation/editing application 336. As shown in FIG. 8B, the exemplary contacts databases 310, 314, 318 are functionally connected to both the contact viewing application 334 and the contact creation/editing application 336 to facilitate the addition, deletion and modification of contacts using the contact creation/editing application 336 and to facilitate the display of contacts from different contacts databases in the same view.

Functional features of the contact viewing application 334 include a contact viewer 338 and a contact collector 340. The contact viewer 338 in the present embodiment is in the form of a software module that is responsible for displaying a graphical user interface (GUI) via the LCD display 110 for a user of the portable electronic device 100. The GUI provides different display options to permit user-selection of the contacts database(s) for viewing, thereby allowing the user to select from the existing contacts databases for viewing, as will be explained further below.

The contact collector 340 is also in the form of a software module in the present embodiment and is responsible for providing a list of contacts to the contact viewer 338 for display. The list is provided by the contact collector 340 in response to a request from the calendar viewer 338 for contacts in any or all of the contacts databases 310, 314, 318 that meet specified constraints. The constraints include, for example, letters entered into the GUI by the user. Thus, all contacts that include a name that starts with the series of letters entered by the user are collected by the contact collector 340 and displayed using the calendar viewer 338. If no letters are entered, all contacts in any or all the contacts databases 310, 314, 318 are provided. The contacts displayed include only those contacts from the contacts databases 310, 314, 318 selected for viewing by the user.

The contact creation/editing application 336 is also responsible for displaying a GUI via the LCD display 110 for a user of the portable electronic device 100. This GUI is specific for creating and editing contacts and permits user creation, modification and deletion of contacts including adding or editing of information by user entry into fields such as the first name, last name, email address, or other fields for a contact. The contact creation/editing application 336 permits user-selection of which one of the contacts databases 310, 314, 318 a new appointment is added to. Thus, the user can add to any one of the calendar databases 310, 314, 318 by selecting the database for storage of a new contact during creation of the data record.

The contact viewer 338 is responsible for displaying a contact GUI to the LCD display 100 and updating the LCD display 100 in response to user interactions with the GUI such as adding letters in a series for searching for a contact and selecting the contacts databases 310, 314, 318 to be included in the display. In order to display contacts that include a particular sequence of letters, the contact viewer 338 receives input by user-entry using, for example, the keyboard 116. If no letters are entered, all contacts from the selected contacts databases are provided for display. The contacts viewer 338 requests from the contact collector 340 an alphabetical list that meets the constraints. When received from the contact collector 340, the contact viewer 330 causes each contact to be rendered in alphabetical order.

The contact collector 340 is responsible for alphabetical collection of time-dependent events based on the request received from the contact viewer 338. Thus, the contact collector 340 returns a list of contacts from all of the selected calendar databases 310, 314, 318 that fall within the constraints defined in the request. The list of contacts is ordered and provided to the contact viewer 338 for rendering. The contact collector 340 also includes a cache for storage of recently collected lists.

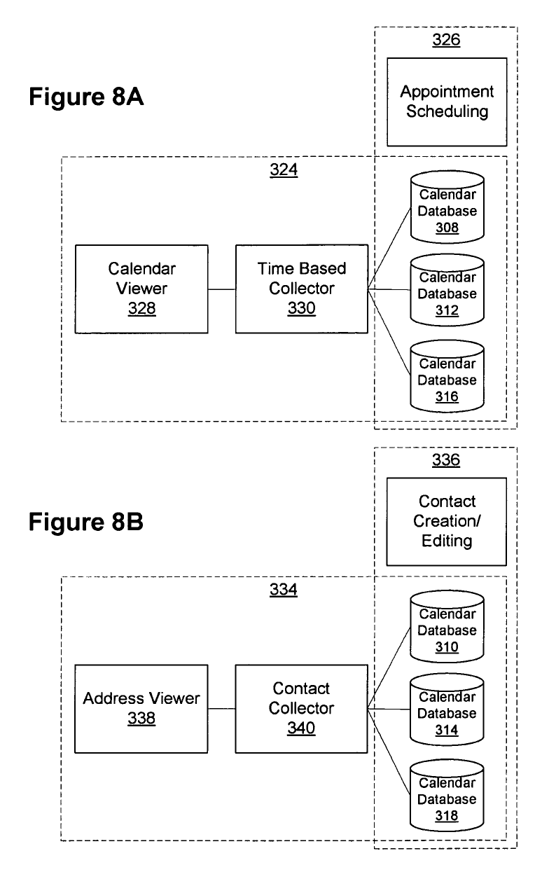

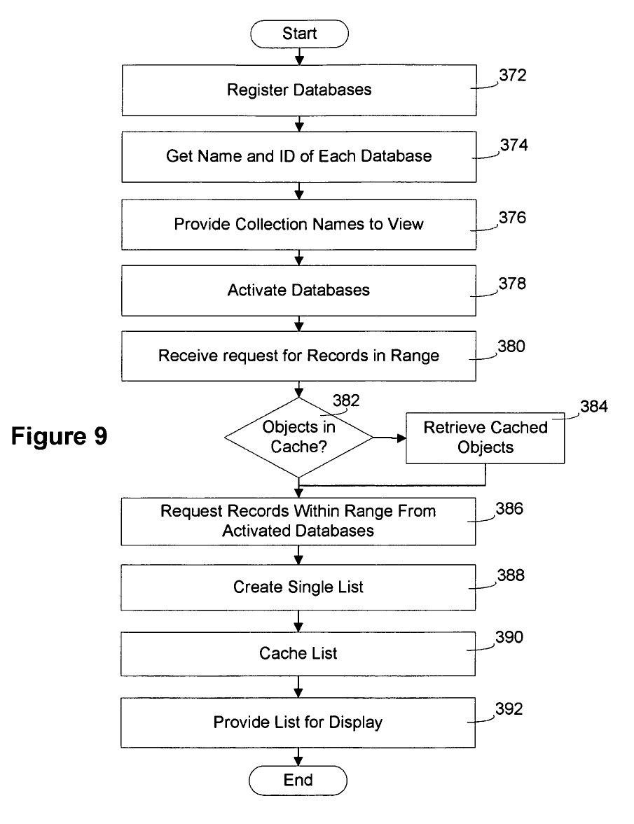

Reference is now made to FIG. 9, which shows a flowchart illustrating steps carried out at the portable electronic device 100 during displaying of a view in a PIM application such as a calendar view or an address book view according to one aspect of an embodiment. Coding of software for carrying out such steps is well within the scope of a person of ordinary skill in the art. For the purpose of the present explanation, particular examples of a calendar view and of an address book view will be described.

At step 372, each of the calendar databases 308, 312, 316 is registered by the PIM service manager application 300 (shown in FIG. 6), with the time-based collector 330 such that the calendar databases 308, 312, 316 are included in the display by the calendar viewer 328. Next, the time-based collector 340 obtains the name and identification for each of the PIM service accounts with respective calendar databases 308, 312, 316 from the PIM service manager application 300 (which originally received the name from the PIM service record 302, 304, 306), to provide names associated with each database and thereby identify the database to the user, at step 374. These names are provided to the calendar viewer 328 and are displayed to the user on the LCD display 110 for user selection of which ones of the calendar databases 308, 312, 316 to display data from (step 376), if and when the user interacts with the GUI to select specific ones or all of the calendar databases 308, 312, 316. The ones of the calendar databases 308, 312, 316 that are selected for display are then activated at step 378, either in response to user selection using the GUI or by a default selection if the user does not select or unselect any of the calendar databases 308, 312, 316.

At step 380, the user interacts with the GUI presented by the calendar viewer 328 to select a calendar display view that the user wishes to have displayed on the LCD display 110 of the portable electronic device 100, thereby effectively requesting a display of all time-dependent events within a time range defined by the selected calendar display view. Alternatively, a default calendar display view can be selected with a default time range. Based on the user interaction with the GUI or the default display on startup of the calendar viewing application 334, a request for time-dependent events within the time range is received at the time-based collector 330 from the calendar viewer 328.

At step 382, it is determined if any time-dependent events are stored in the time-based collector cache that meet the time range constraint and that are from the selected databases and therefore activated databases 308, 312, 316. The cache is used for storing a list of time-dependent events recently provided to the calendar viewer 328 and aids in reducing overall response time for displaying time-dependent events when requested. The cache is limited in size and only maintains more recently stored lists of time-dependent events. If, for example, a user recently requested a display of time-dependent events falling within the time range, these time-dependent events are stored in the cache and are retrieved from the cache at step 384. If no such previous request was made, however, the cache does not include any such time-dependent events.

At step 386, the time-based collector 330 retrieves all the time-dependent events from each of the calendar databases 308, 312, 316 that were previously activated by user selection or by a default selection for display and that meet the time range constraint, for example, by having a start time and/or an end time (determined by the start time and the duration) that falls within the defined time range. The time-dependent events that meet the time range constraint are added in a time-ordered list based on the start time of the time-dependent event at step 388 by way of a merge and sort algorithm. In the present embodiment, the list is a list of pointers, indexing the record in the calendar database 308, 312, or 316 to which it belongs. The list is added to the cache at step 390 and is provided to the calendar viewer 328 and displayed on the LCD display 110 at step 392.

The calendar viewer 328 uses information regarding the selected calendar view, including the time range to be displayed as well as the granularity of the time slots within the displayed screen, along with the information from each of the time-dependent events that were included in the list, such as the start time and duration, to determine where to render the time-dependent event in the view.

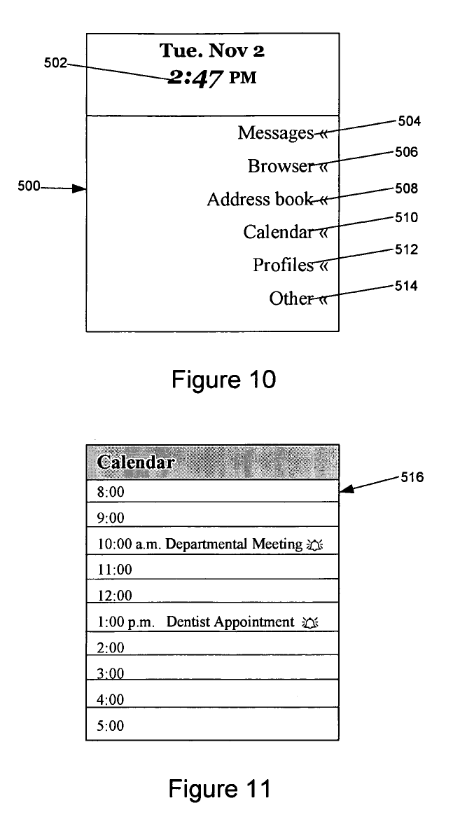

Reference is now made to FIG. 10 to 13, which show exemplary screen shots displayed on the LCD display according to one embodiment. The screen shots shown are provided for exemplary purposes and are not intended to be limiting. FIG. 10 shows an exemplary menu screen that is displayed on the LCD display 110 of the portable electronic device 100 (the remainder of the portable electronic device 100 is not shown in FIG. 10). The exemplary menu screen 500 includes a display clock 502 that is updated according to an internal clock. As indicated above, the electronic device 100 is operable to execute various applications stored in the flash memory 108. In the exemplary screen of FIG. 10, these applications include, for example, a Messages application 504, a Web browser application 506, an Address book application 508, a Calendar application 510, a Profiles application 512, and Other applications 514. An input device such as the trackball 113 can be used for scrolling through the applications and for selecting a desired application by depressing the trackball 113. The exit key 172 on the keyboard 116 is used for exiting any application.

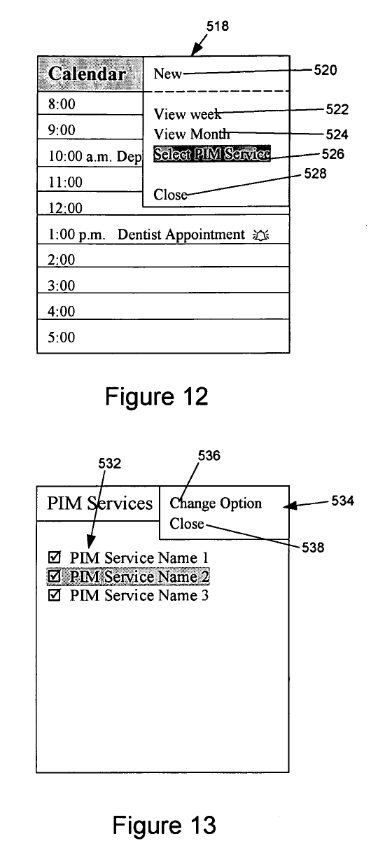

Selection of the Calendar application 510 from the menu screen 500 shown in FIG. 10 causes the processor 102 to execute the calendar viewing application 324, providing the calendar viewer GUI via the LCD display 110 for the user of the portable electronic device 100, as shown in FIG. 11. In the present embodiment, the LCD display 110 shows a default day view 516 upon startup. As referred to above, the display can be selectively manipulated and displayed in various views including monthly, weekly or daily. The trackball 113 is depressed to cause a submenu 518 to be displayed on the LCD display 110 for selection of different calendar views, as shown in FIG. 12.

The submenu in FIG. 12 includes different options for user selection, including, for example, New 520, View Week 522, View Month 524, Select Calendar Service 526 and Close 528 options. Selection of the New option 520 causes execution of the appointment scheduling application 326, thereby providing the appointment scheduling GUI to the user for composition of a new appointment record. Selection of the View Week option 522 results in the display of the weekly schedule for the week including the day displayed in the day view 516 in FIG. 11. Selection of the View Month option 524 results in the display of the monthly schedule for the month including the day displayed in the day view 516 in FIG. 11. It will be appreciated that when in the week view, the calendar view options provided are View Month 524 and View Day (not shown). Similarly, when in the month view, the calendar view options provided are View Week 522 and View Day (not shown). Selection of the Select Calendar Service option 526 results in the display of a list of the PIM services with associated calendar databases, selectable by the user and identified by the name provided to the calendar viewer 328 at step 376 described above with reference to FIG. 9. Thus, the Select Calendar Service option 526 allows the user to select PIM services by name, thereby selecting the calendar databases 308, 312, 316 from which data records are collected. Selection of the Close option 528 closes the Calendar application.

Selection of the Select Calendar Services option 526 results in the display of the selection screen 530 shown in FIG. 13, which shows the list of PIM services with associated calendar databases, corresponding to PIM services 532 available on the portable electronic device 100 and selectable by user selection of the checkbox next to the name identifying the database. The associated calendar databases of the ones of the PIM services 532 that are selected are activated at step 378 described above and time-dependent events from those calendar databases 308, 312, 316 are therefore collected for display in the calendar view. The ones of the calendar databases with associated PIM services 532 that are not selected for display are not activated at step 378 and are therefore not displayed in the calendar view. Thus, the calendar databases 308, 312, 316 can be selected or unselected by scrolling down to the checkbox next to the associated PIM service in the list of PIM services 532 that the user wishes to select (if the checkbox is not selected) or unselect (if the checkbox is selected) using the trackball 113 followed by depression of the trackball 113. The user is then presented with the submenu 534 as shown in FIG. 13, which provides the user with the option to “Change Option” 536 or close 538. Selection of the Change Option 536 causes the checkbox to change to selected (if it was previously not selected) or to not selected (if it was previously selected).

Reference is again made to FIG. 9 to describe the steps carried out at the portable electronic device 100 during displaying of an address book view according to a particular example. At step 372, each of the contacts databases 310, 314, 318 is registered by the PIM service manager application 300 (shown in FIG. 6), with the contact collector 340 such that the contacts databases 310, 314, 318 are included in the display by the contact viewer 338. Next, the contact collector 340 obtains the name and identification (User ID) of each of the contacts databases 310, 314, 318 from the PIM service manager application 300 (which originally received the name from the PIM service record 302, 304, 306), to provide names associated with each database and thereby identify the database to the user, at step 374. These names are provided to the contact viewer 338 and are displayed to the user on the LCD display 110 for user selection of which ones of the contacts databases 310, 314, 318 to display (step 376), if and when the user interacts with the GUI to select specific ones or all of the contacts databases 310, 314, 318. The ones of the contacts databases 310, 314, 318 that are selected for display are then activated at step 378, either in response to user selection using the GUI or by a default selection if the user does not select or unselects any of the contacts databases 310, 314, 318.

At step 380, the user interacts with the GUI presented by the contact viewer 338 to input letters in a sequence for searching for particular contacts to be included in the display. In order to display contacts that include a particular sequence of letters, the contact viewer 338 receives input by user-entry using, for example, the keyboard 116, thereby effectively requesting a display of all contacts that include the sequence of letters defined by the selected calendar display view. Alternatively, a default contact display view can be provided with an alphabetical list. Based on the user interaction with the GUI or the default display on startup of the contact viewing application 334, a request for contacts is received at the contact collector 340 from the contact viewer 338.

At step 382, it is determined if any contacts are stored in the contact collector cache that meet the constraints and that are from the selected databases (by user-selection of the PIM service) and therefore activated contacts databases 310, 314, 318. The cache is used for storing a list of contacts recently provided to the contact viewer 338 and aids in reducing overall response time for displaying contacts when requested.

At step 386, the contact collector 340 retrieves all the contacts from each of the contacts databases 310, 314, 318 that were previously activated by user selection or by a default selection for display and that meet the constraints, for example, by having a sequence of letters in the contacts that match a user-input sequence of letters. The contacts that meet the constraint are added in an alphabetically-ordered list at step 388 by way of a merge and sort algorithm. The list is added to the cache at step 390 and is provided to the contact viewer 338 and displayed on the LCD display 110 at step 392.

It will now be appreciated that data records from more than one PIM service account can be stored at the portable electronic device 100 in separate databases. Thus, more than one PIM database can be maintained at the portable electronic device 100 including more than one database for a PIM application. For example, a plurality of calendar databases can be maintained, each relating to a different PIM service account. Similarly, a plurality of contacts databases can be maintained, each relating to a different PIM service account. The PIM data records including the time dependent events and contacts can be displayed with distinguishing characteristics or distinguishing features in order to identify the PIM service account to which the PIM data records belong. Thus, the PIM data records can be displayed in different colours depending on which database the PIM data records are retrieved from. Alternatively, the PIM data records can be displayed with distinguishing icons or other features to represent the PIM service to which each data record belongs. Further, the contacts databases from which contacts are displayed can be selectable in a similar to manner to the selection of the calendar databases as described above with reference to FIGS. 11 to 13.

Reference is now made to FIG. 14, which shows a flowchart illustrating steps in a method of managing storage of data at an electronic device according to an embodiment of the present application. Coding of software for carrying out such steps is well within the scope of a person of ordinary skill in the art. At step 400, the PIM databases are maintained. Step 400 includes a number of sub-steps as described hereinabove with reference to FIG. 7A. A user-selection of one of the PIM data records is received at step 402. This can be received by, for example, user-scrolling in a PIM application GUI at the portable electronic device 100, followed by selection of the PIM data record represented on the LCD display 110. An option to save the selected PIM data record to another database is provided and a user-selection of the option to save the selected PIM data record to another database is received at step 404. The PIM service accounts registered at the portable electronic device 100 are then determined to provide a list of PIM service accounts with associated databases available to move or copy the PIM data record to (step 406). The PIM service accounts are displayed for user-selection and the user-selection of one of the PIM service accounts is received at step 408. The PIM data record selected at step 402 is then stored in the database associated with the user-selected PIM service account (step 410). Next, the synchronization capabilities of the selected PIM service account are determined from the associated one of the PIM service records (step 412). If the synchronization capabilities as defined in the PIM service records permit (step 414), the data record is also sent to the selected PIM service account for storage in a corresponding database at the PIM service (step 416). If the user-selection received at step 404 is determined to be the copy option at step 418, the process ends. If, on the other hand, the user-selection received at step 404 is determined to be the move option, the process proceeds to step 420 where the data record selected at step 402 is deleted from the original database in which the data record was stored prior to user-selection of the move option at step 404. The synchronization capabilities of the PIM service account associated with the original database in which the data record was stored prior to user-selection of the move option, are determined from the associated one of the PIM service records (step 422). If the synchronization capabilities as defined in the PIM service records permit (step 424), a delete command is sent to the PIM service associated with the original database in which the data record was stored prior to user-selection of the move option to delete the data record stored in the PIM service account associated with the original database.

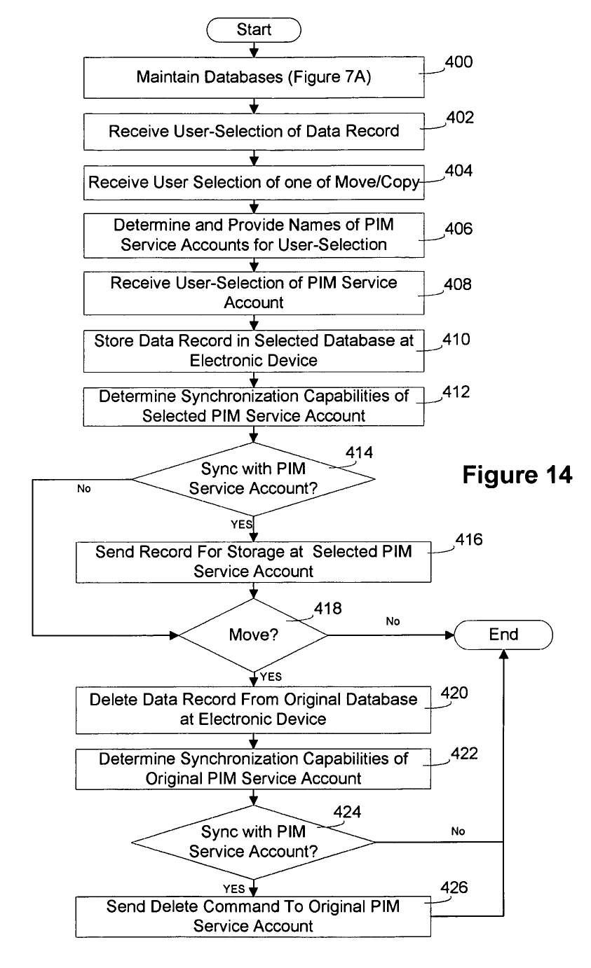

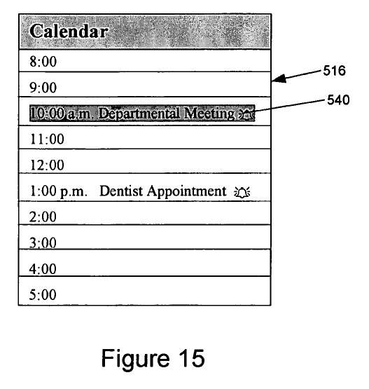

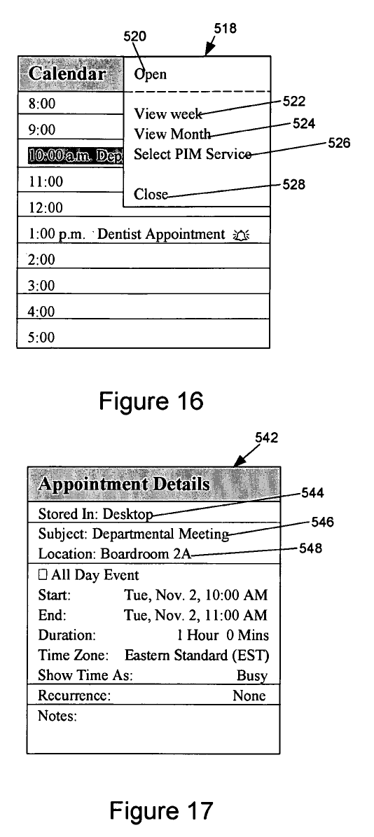

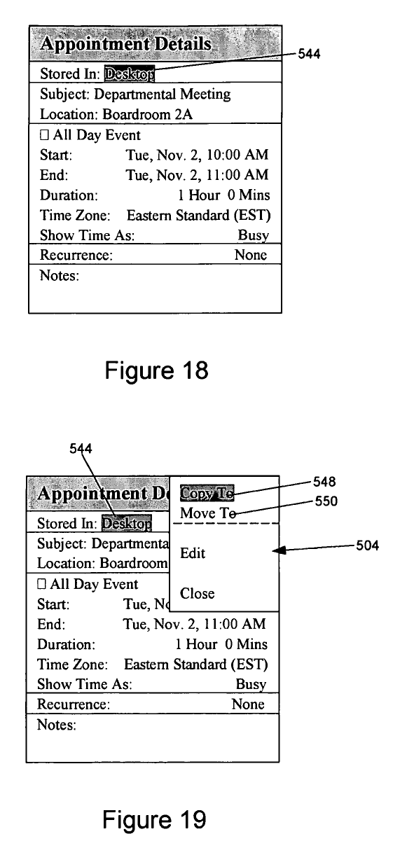

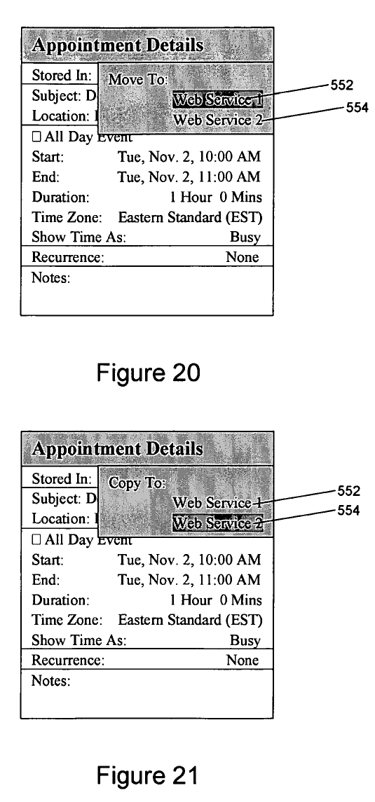

Reference is now made to FIG. 14 and to FIGS. 15 to 21 which show exemplary screen shots in the method of managing storage of data. FIGS. 15 to 21 relate to calendar data. These Figures are provided for exemplary purposes and are not intended to be limiting. As described above, the calendar databases 308, 312, 316 are maintained at the portable electronic device 100 (step 400). A user-selection of one of the time-dependent events is received at step 402. This can be received by, for example, user-scrolling to the time-dependent event when in the calendar day view 516, as shown in FIG. 15, followed by selection of the calendar data event represented in the calendar view on the LCD display 110. In the present example, the user scrolls to the “Departmental Meeting” 540 scheduled for 10:00 a.m. as shown in FIG. 15 and depresses the trackball 113, resulting in the display of the submenu 519 as shown in FIG. 16. The time-dependent event is then opened by user-selection of the Open option 521 shown in FIG. 16, resulting the display of the details of the time-dependent event data record, as shown in FIG. 17. The remainder of the options shown in the submenu 519 of FIG. 16 are similar to those in the submenu 518 shown in FIG. 12. Referring again to FIG. 17, the Appointment Details 542 (details of the time-dependent event) include the PIM service account that the time-dependent event is stored in, in a “Stored In” field 544 which in the present example is “Desktop”. Thus, the “Departmental Meeting” 540 is stored in the calendar database associated with the user's desktop and therefore is stored in host system 250. The Appointment Details 542 include other information fields such as a Subject field 546 populated with “Departmental Meeting”, a Location field 548 populated with “Boardroom 2A” as well as other information fields. Next, the user is provided with the option to save the selected “Departmental Meeting” time-dependent event in another database and the user-selection of the option to save the selected “Departmental Meeting” time-dependent event in another database is received at step 404. The option to save by moving or copying the time-dependent event is selected by, for example, scrolling to highlight “Desktop” in the “Stored In” field 544, as shown in FIG. 18, followed by user-depression of the trackball 113, resulting in the display of the submenu 546 shown in FIG. 19. The user can then select to save the “Departmental Meeting” time-dependent event in another database by scrolling to highlight either of the “Copy To” 548 or the “Move To” 550 options shown in the submenu of FIG. 19. Selection of either of the options 548, 550 results in the determination of the PIM service accounts registered at the portable electronic device 100 to provide a list of PIM service accounts with associated databases available to move or copy the “Departmental Meeting” time-dependent event to (step 406). In the present example, the “Departmental Meeting” is being moved from or copied from the “Desktop” calendar database at the portable electronic device 100 as shown in the “Stored In” field 548. Thus, the remaining PIM service accounts (those PIM service accounts that are not associated with the “Desktop” calendar database are displayed. In the examples described above, there are a total of three calendar databases 308, 312, 316. Thus, if one calendar database 308 is associated with the “Desktop”, the names of the remaining two PIM service accounts with associated calendar databases 312, 316 are displayed for user-selection. In exemplary FIGS. 20 and 21, the two PIM service accounts associated with the calendar databases 312, 316 are “Web Service 1” 552 and “Web Service 2” 554. Thus, in FIG. 20, user-selection of the “Move To” option 550 is received at step 404 and the names of the PIM service accounts with associated databases 312, 316 at the portable electronic device 100 are displayed at step 406. A user-selection of, for example, “Web Service 1” 552 is received at step 408. Thus, the user has selected to move the “Departmental Meeting” calendar event data record to the database 312 associated with the “Web Service 1” PIM service account. The “Departmental Meeting” time-dependent event is then stored in the database 312 in association with the “Web Service 1” PIM service account, using the unique service identification (step 410). Next, the synchronization capabilities of the “Web Service 1” PIM service account are determined from the associated PIM service record 304 (step 412). If the synchronization capabilities as defined in the PIM service record 304 permit (step 414), the “Departmental Meeting” time-dependent event is also sent to the “Web Service 1” PIM service for storage in a corresponding database at the PIM service (step 416). With user-selection of the “Move To” option 550 (step 418), the process proceeds to step 420 where the “Departmental Meeting” time-dependent event is deleted from the calendar database 308 in which the “Departmental Meeting” time-dependent event was stored prior to user-selection of the “Move To” option 550. The synchronization capabilities of the PIM service account associated with the database 308 are then determined from the associated PIM service record 302 (step 422). If the synchronization capabilities as defined in the PIM service record 302 permit (step 424), a delete command is sent to the “Desktop” PIM service (the host computer system 250) to delete the “Departmental Meeting” data record stored in the host computer system 250 (step 426).

If, on the other hand, user-selection of the “Copy To” option 548 is received at step 404, as shown in FIG. 21, the names of the PIM service accounts with associated databases 312, 316 at the portable electronic device 100 are displayed at step 406. A user-selection of, for example “Web Service 2” 554 PIM service account is received at step 408. Thus, the user selects the “Copy To” option 548 to copy the “Departmental Meeting” calendar event data record to the database 316 associated with the “Web Service 2” PIM service account. The “Departmental Meeting” time-dependent event is then stored in the database 316 in association with the “Web Service 2” PIM service account using the unique service identification (step 410). Next, the synchronization capabilities of the “Web Service 2” PIM service account are determined from the associated PIM service record 306 (step 412). If the synchronization capabilities as defined in the PIM service record 306 permit (step 414), the “Departmental Meeting” time-dependent event is also sent to the “Web Service 2” PIM service for storage in a corresponding database at the PIM service (step 416). Since the user-selected the “Copy To” option 548 (step 418), the process ends.

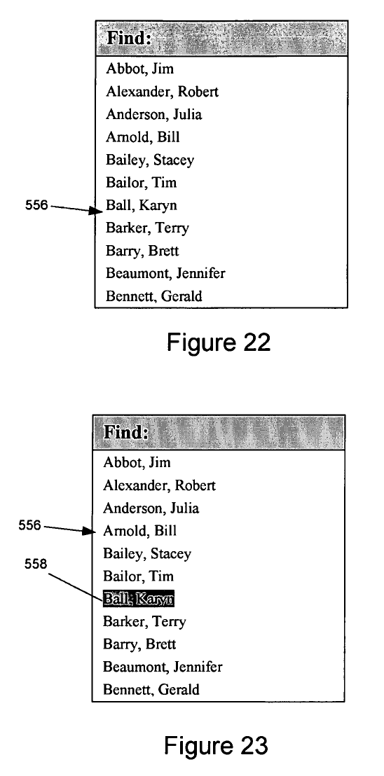

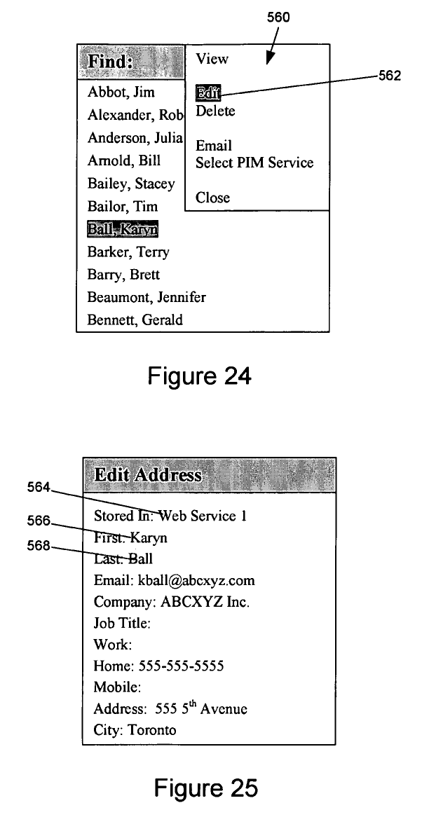

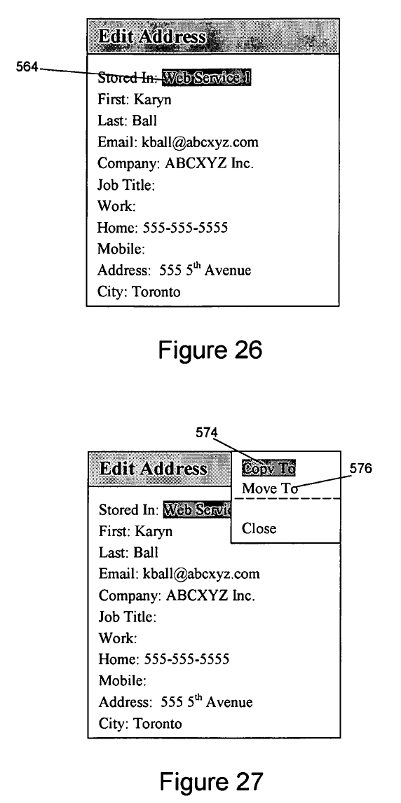

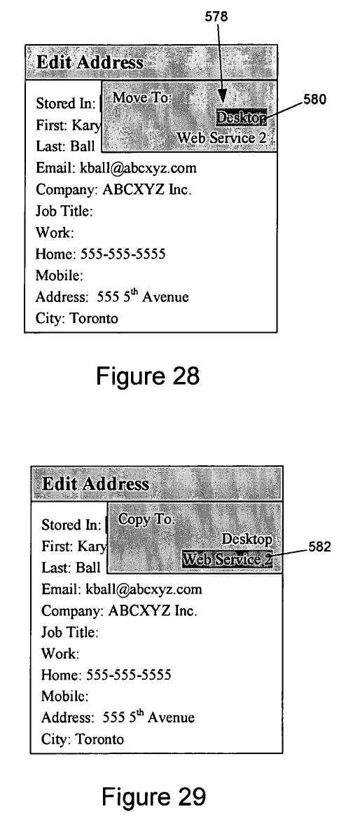

Reference is now made to FIG. 14 and to FIGS. 22 to 29 which show exemplary screen shots in the method of managing storage of data. FIGS. 22 to 29 relate to address book data. These Figures are provided for exemplary purposes and are not intended to be limiting. As described above, the contacts databases 310, 314, 318 are maintained at the portable electronic device 100 (step 400). A user-selection of one of the contacts is received at step 402. This can be received by, for example, user-scrolling to the desired contact, identified by the contact name when in the address book view 556, as shown in FIGS. 22 and 23, followed by selection of the contact represented in the address book view 556 on the LCD display 110. In the present example, the user scrolls to the “Ball, Karyn” contact 558 as shown in FIG. 23 and depresses the trackball 113, resulting in the display of the submenu 560 as shown in FIG. 24. The contact is then opened by user-selection of the Edit option 562 shown in FIG. 24, resulting the display of the details of the contact, as shown in FIG. 25. As shown, the editable fields of the contact include the PIM service account that the contact is stored in, (in the “Stored In” field 564) which in the present example is “Web Service 1”. Thus, the “Ball, Karyn” contact 558 is stored in the contacts database associated with the “Web Service 1” PIM service account. The details of the contact include other information in fields such as a “First” name field 566 populated with the name “Karyn”, a “Last” name field 568 populated with the name “Ball” as well as other fields. Next, a user-selection of an option to save the selected “Ball, Karyn” contact 558 in another database is received at step 404. The option to save by moving or copying the contact is selected by, for example, scrolling to highlight “Web Service 1” in the “Stored In” field 564, as shown in FIG. 26, followed by user-depression of the trackball 113, resulting in the display of the submenu 572 shown in FIG. 27. The user can then select to save the “Ball, Karyn” contact 558 in another database by scrolling to highlight either the “Copy To” option 574 or the “Move To” option 576 shown in the submenu of FIG. 27. Selection of either of these options 574, 576 results in the determination of the PIM service accounts registered at the portable electronic device 100 to provide the list of PIM service accounts 578 with associated contacts databases available to move or copy the “Ball, Karyn” contact 558 to (step 406). In the present example, the “Ball, Karyn” contact 558 is being moved from or copied from the contacts database 314 associated with the “Web Service 1” PIM service account. Thus, the remaining names of associated PIM service accounts are displayed in the list of PIM service accounts 578. In the examples described above, there are a total of three contacts databases 310, 314, 318. Thus, if one contacts database 314 is associated with the “Web Service 1” PIM service account, the names of the remaining two PIM service accounts with associated contacts databases 310, 318 are displayed for user-selection. In exemplary FIGS. 28 and 29, the two PIM service accounts associated with the contacts databases 310, 318 are “Desktop” and “Web Service 2” and are displayed in the list of PIM service accounts 578. Thus, in FIG. 28, the user-selection of the “Move To” option 576 is received at step 404 and the names of the PIM service accounts with associated databases 310, 318 at the portable electronic device 100 are displayed in a list, each name being user-selectable, at step 406. A user-selection of, for example “Desktop” 580 is received at step 408. Thus, the user has selected to move the “Ball, Karyn” contact to the database 310 associated with the “Desktop” PIM service account. The “Ball, Karyn” contact is then stored in the database 310 in association with the “Desktop” PIM service account using the unique service identification (step 410). Next, the synchronization capabilities of the “Desktop” PIM service account are determined from the associated PIM service record 302 (step 412). If the synchronization capabilities as defined in the PIM service record 302 permit (step 414), the “Ball, Karyn” contact 558 is also sent to the “Desktop” PIM service (the host computer system 250) for storage in a corresponding database at the host computer system 250 (step 416). Since the user-selected the “Move To” option 576 (step 418), the process proceeds to step 420 where the “Ball, Karyn” contact 558 is deleted from the contacts database 314 in which the contact was stored prior to user-selection of the “Move To” option 576. The synchronization capabilities of the PIM service account associated with the contacts database 314 are then determined from the associated PIM service record 304 (step 422). If the synchronization capabilities as defined in the PIM service record 304 permit (step 424), a delete command is sent to the “Web Service 1” PIM service to delete the “Ball, Karyn” contact 558 stored in the “Web Service 1” PIM service account.

If, on the other hand, the “Copy To” option 574 is selected, as shown in FIG. 29, the user-selection of the “Copy To” option 574 is received at step 404 and the names of the PIM service accounts with associated databases 310, 318 at the portable electronic device 100 are displayed at step 406. A user-selection of, for example “Web Service 2” 582 is received at step 408. Thus, the user has selected the “Copy To” option 574 to copy the “Ball, Karyn” contact 558 to the database 318 associated with the “Web Service 2” PIM service account. The “Ball, Karyn” contact 558 is then stored in the database 318 in association with the “Web Service 2” PIM service account using the unique service identification (step 410). Next, the synchronization capabilities of the “Web Service 2” PIM service account are determined from the associated PIM service record 306 (step 412). If the synchronization capabilities as defined in the PIM service record 306 permit (step 414), the “Ball, Karyn” contact 558 is also sent to the “Web Service 2” PIM service for storage in a corresponding database at the PIM service (step 416). Since the user-selected the “Copy To” option 574 (step 418), the process ends.

In the preceding description, for purposes of explanation, numerous details are set forth in order to provide a thorough understanding of the embodiments of the present application. However, it will be apparent to one skilled in the art that certain specific details are not required. In other instances, features, including functional features, are shown in block diagram form in order not to obscure the description. Further, certain Figures and features are simplified for ease of understanding and certain. In some cases, for example, specific details are not provided as to whether the embodiments described herein are implemented as a software routine, hardware circuit, firmware, or a combination thereof.

Embodiments can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment. Those of ordinary skill in the art will appreciate that other instructions and operations necessary to implement the described features can also be stored on the machine-readable medium. Software running from the machine-readable medium can interface with circuitry to perform the described tasks.

In a first aspect, there is provided a method of managing storage of data at an electronic device includes maintaining databases associated with respective PIM service accounts including at least a first database associated with a first PIM service account and a second database associated with a second PIM service account, receiving a selection of an option to save a data record stored in the first database to the second database, and storing the record in the second database.

In a further aspect, there is provided a portable electronic device. The electronic device includes a memory for storage of databases associated with respective PIM service accounts, a display device for displaying data from data records stored in the databases, an input device for selection of options for storage of the data records, and a processor. The processor is connected to the memory, the display device and the input device for execution of an application for receiving a selected option to save one of the data records stored in a first one of the databases to a second one of the databases and, in response, storing the data record in the second one of the databases.

In a further aspect, there is provided a computer readable medium having computer-readable code embodied therein for execution by a processor at a computing device for maintaining databases associated with respective PIM service accounts including at least a first database associated with a first PIM service account and a second database associated with a second PIM service account, receiving a selection of an option to save a data record stored in the first database to the second database, and storing the record in the second database.

Advantageously, the PIM data records such as time dependent event data records and contact data records from different PIM services can be selectively displayed in graphical user interfaces on the electronic device. Thus, for example, time-dependent event data records from each different service are stored in separate databases associated with the PIM service to which the data records belong, to thereby keep these events separated. Thus, time-dependent event data records from one PIM service are stored in a database for the time-dependent event data records of that PIM service. Similarly, contact data records from each different service are stored in separate databases associated with the PIM service to which the data records belong. Further, the PIM data records can be moved or copied from a database associated with one PIM service to a database associated with another PIM service. Where a user, for example, maintains a PIM service for storage of personal data records and a separate PIM service for storage of business data records, for example, the data records can be selectively transferred from one database at the portable electronic to the other.

The storage of data records in respective databases permits viewing of data records in separate lists thereby allowing a user to select and view only PIM data records of particular interest on the display device of the portable electronic device. Transferring by copying or moving PIM data records allows a user to gather data records of interest into a single database, thereby permitting viewing of all data records of interest from the associated database without having to view all PIM data records from other databases that are not of particular interest. Thus, for example, a user can keep personal and business contacts in separate databases. Similarly, a user can keep personal and business time-dependent events in separate databases. This permits rendering of records from a single database when the user is interested only in records from that database. Rendering of PIM data records from only one of a number of PIM databases reduces processing time at the portable electronic device as only data records from the one database of interest are collected and then rendered on the display device. Absent the ability to transfer records by copying or moving, viewing data records stored in separate databases requires that the user view the data records from more than one database. Thus, the data records from more than one database must be collected and then rendered, requiring additional processing time for collection of data records from multiple databases. Alternatively, the user must enter all the data in a new data record for storage in the desired database taking additional user time for entry and consuming battery resources as display screen power is required during user entry of the “new” data record.

While the embodiments described herein are directed to particular implementations of the electronic device and method of managing storage of data, it will be understood that modifications and variations to these embodiments are within the scope and sphere of the present application. For example, many of the options provided in menus and submenus and the details displayed in the screen shots provided are shown for exemplary purposes and such options and details can vary. Further, particular reference has been made to time-dependent events and to contacts throughout the description. These references are provided for the exemplary purposes and the present application is not limited to time-dependent events or to contacts as other PIM databases can be maintained for storage of other PIM data records such as, for example, tasks and memos.

The above-described embodiments are intended to be examples only. Alterations, modifications and variations can be effected to the particular embodiments by those of skill in the art without departing from the scope of the present application, which is defined solely by the claims appended hereto.

What is claimed is:

1. A method of managing storage of data at an electronic device, the method comprising:
maintaining databases associated with respective PIM service accounts including at least a first database associated with a first PIM service account and a second database associated with a second PIM service account;
providing a selectable option to save a data record stored in the first database to the second database; and
storing the data record in the second database if a selection of said option to save the data record is received.

2. The method according to claim 1, wherein providing the selectable option to save the data record comprises providing at least one of an option to move the data record and an option to copy the data record.

3. The method according to claim 1, wherein the option to save the data record comprises an option to move the data record.

4. The method according to claim 3, comprising deleting the data record from the first database in response to receipt of selection of the option to move the data record.

5. The method according to claim 1, wherein the data record comprises one of a time-dependent event data record and an address data record.

6. The method according to claim 1, comprising maintaining a first PIM service record associated with the first database and the first PIM service account and maintaining a second PIM service record associated with the second database and the second PIM service account.

7. The method according to claim 6, wherein the first PIM service record includes synchronization capabilities of the first PIM service account and the second PIM service record includes synchronization capabilities of the second PIM service account.

8. The method according to claim 7, wherein the method comprises, in response to receipt of the selection of said option to save the data record, sending the data record for storage in an associated database at the second PIM service account if the synchronization capabilities permit.

9. The method according to claim 7, wherein the method comprises, in response to receipt of the selection of said option to save the data record, deleting the data record from the first database and sending a delete command for deleting the data record at the first PIM service account if the synchronization capabilities permit.

10. An electronic device comprising:
a memory for storage of databases associated with respective PIM service accounts;
a display device for displaying data from data records stored in the databases;
an input device for selection of options for storage of the data records; and
a processor connected to the memory, the display device and the input device, for execution of an application for providing a selectable option to save a data record stored in a first one of the databases to a second one of the databases, and storing the data record in the second one of the databases if a selection of the option to save the data record is received.

11. A computer readable medium having computer-readable code embodied therein for execution by a processor at a computing device for:
maintaining databases associated with respective PIM service accounts including at least a first database associated with a first PIM service account and a second database associated with a second PIM service account;
providing a selectable option to save a data record stored in the first database to the second database; and
storing the data record in the second database if a selection of said option to save the data record is received.
